(19) United States
(12) Patent Application Publication
(10) Pub. No.: US 2024/0007398 A1
(43) Pub. Date: Jan. 4, 2024

(54) NEXT-HOP MONITORING METHOD FOR BORDER GATEWAY PROTOCOL IN LAYER 3 VIRTUAL PRIVATE NETWORK MODELS

(71) Applicant: VIETTEL GROUP, Ha Noi City (VN)

(72) Inventors: Dinh Tho Luong, Yen My District (VN); Dinh Dung Bui, Duc Tho District (VN); Van Huong Tran, Ha Noi City (VN)

(73) Assignee: VIETTEL GROUP, Ha Noi City (VN)

(21) Appl. No.: 18/344,508

(22) Filed: Jun. 29, 2023

(30) Foreign Application Priority Data
Jun. 30, 2022 (VN) 1-2022-04146

(51) Int. Cl. H04L 45/74; H04L 45/50; H04L 12/46

(52) U.S. Cl. CPC H04L 45/74; H04L 45/507; H04L 12/4641

(57) ABSTRACT

The present invention provides next-hop monitoring method for border gateway protocol in layer 3 virtual private network models. The invention helps determine the fastest possible next hops of a route. If the next-hop is invalid or there is a change in cost when it comes to the next-hop, an update is needed to ensure convergence time.

### TECHNICAL FIELD OF THE INVENTION

The invention concerns a method of Border Gateway Protocol (BGP) next-hop monitoring in a Layer 3 virtual private network (L3VPN) model. Specifically, the method verifies learned route information over BGP by monitoring the validity of the route's next hop in the L3VPN model.

### BACKGROUND OF THE INVENTION

The internet is decentralized and interconnected by Autonomous Systems (ASs). Each AS is managed by a Service provider (Internet Service Provider—ISP) to provide Internet and Virtual Private Network (VPN) services. Currently, Border Gateway Protocol (BGP) is the only routing protocol used for routing between different ASs.

Layer 3 Virtual Private Network (L3VPN) is one of the most popular and important VPN applications, deployed on Multi Protocol Label Switching (MPLS) technology combined with BGP. For service providers, L3VPN allows simultaneous transport of multiple users' data through a shared core network. The L3VPN model has three main types of devices: routers located at the provider's edge (Provider Edge—PE), routers located at the user's edge (Customer Edge—CE), and devices located inside the provider's network (Provider-P). To establish a L3VPN channel, the service provider must establish the BGP VPN address family between PE devices. At each PE device, there will be Virtual Routing and Forwarding (VRF) tables corresponding to different users. The user's route information will be stored in VRF tables and advertised over the BGP protocol.

The BGP protocol has its own routing tables, which will also contain the user's route information. Each route information will include the next-hop address field—where next to send the packet in order to get to the target. Routes can be either valid or invalid. Of the valid routes, optimal routes that are chosen to forward packets are best routes, while others are non-best routes. The best and valid routes are imported into the VRF tables and advertised by the router to its BGP peers. By default, the BGP protocol will use the BGP scanner process, which performs a next-hop validation of each of the user routes, thereby determines whether to keep them in the VRF table. This process works with a 60 second cycle, i.e. every 60 seconds the validity of the user route is re-examined. This value may be changed, but changing it lower will increase the load on the Central Processing Unit (CPU). Another way to validate these routes is to use the BGP session keepalive timer and the BGP hold timer. Every time the keepalive timer expires, a BGP router sends a keepalive message to its peer to announce that it is still running. Also, if a BGP router does not receiver a BGP message from a peer before the hold timer ends, the BGP session with this peer will fail, and all the route information learned through this BGP session will be removed by the router. The BGP keepalive timer and hold timer have default values of 60 seconds and 180 seconds, respectively. These can be changed to lower values, but the amount of route information sent through the BGP protocol can be very large, up to tens of thousands of routes, thus doing so will increase CPU processing capacity during route setup and update. Convergence of user routes over the L3VPN channel will depend on the convergence of the BGP protocol, but the convergence time of BGP does not meet the requirements of the user and the service provider itself.

To solve this problem of long L3VPN route convergence time, we propose a BGP next-hop monitoring method which makes this convergence time shorter and independent of the BGP convergence time.

### BRIEF SUMMARY OF THE INVENTION

In order to converge quickly when a route is no longer valid, a router located at the provider edge (PE) must determine the validity of the next-hop for that route very quickly. If the next hop is invalid or there is a change in cost when it comes to the next hop, an update is needed to ensure convergence time.

Thus, the PE has been improved to allow for the fastest identification of valid next hops. The steps to implement this method on the PE device are as follows:

Step 1: The development team made modifications on the open source code that allowed the creation of IP Monitoring (IPM) tables corresponding to the different virtual routing and forwarding (VRF) tables in the layer 3 virtual private network (L3VPN).

Step 2: The development team edited the open source of Border Gateway protocol (BGP) so that when importing user routes into VRF, BGP will also remember the next-hops to follow if the BGP next-hop monitoring function is enabled.

Step 3: Lastly, the development team edited the source code so that if there is a next-hop related change event in the global VRF table, the table will send a notification to the IPM table. The IPM table will then inform the BGP routing table to recalculate the valid routes and the best routes. The notification time from IPM for BGP protocol is configurable, with the minimum of 0 seconds (notify immediately).

### BRIEF DESCRIPTION OF THE DRAWINGS

FIG. 1 depicts the process of setting up a L3VPN channel and advertising user route information over the L3VPN channel.

FIG. 2 depicts the process of setting up and processing the next-hop not using the proposed method

FIG. 3 depicts the process of setting up and processing the next-hop using the proposed method

### DETAILED DESCRIPTION OF THE INVENTION

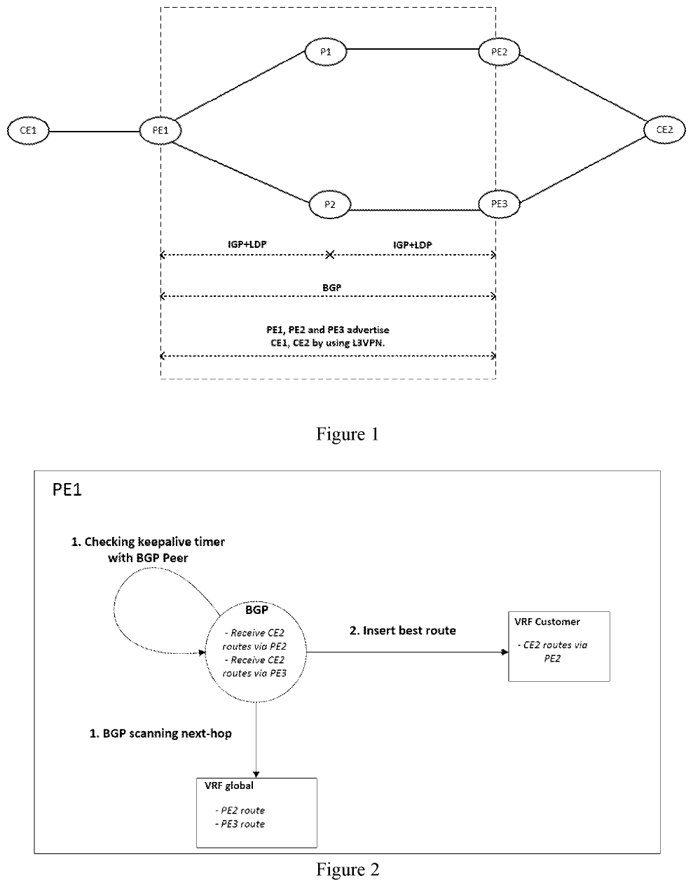

Step 1: The development team made a modification on the PE device that allowed the creation of IP Monitoring (IPM) tables corresponding to the different virtual routing and forwarding (IPM) tables in the layer 3 virtual private network (L3VPN). To do this, a L3VPN channel between different PEs must first be configured. FIG. 1 describes the process of setting up a specific L3VPN channel as follows:
Configure the Open Shortest Path First (OSPF) protocol between devices PE1, P1, P2, PE2, and PE3.
Configure a label broadcasting protocol: Label Distribution Protocol (LDP) or Resource Reservation Protocol (RSVP) between PE1, P1, P2, PE2, and PE3 devices.
Configure the Border Gateway Protocol (BGP) between PE1 and PE2, PE3.
Configure the user VRF information on PE1, PE2 and PE3.
On the PE1 device, in the BGP protocol, configure the next-hop monitoring feature to allow the creation of an IPM table. In this table, at first, there is no information about the next-hops to follow.

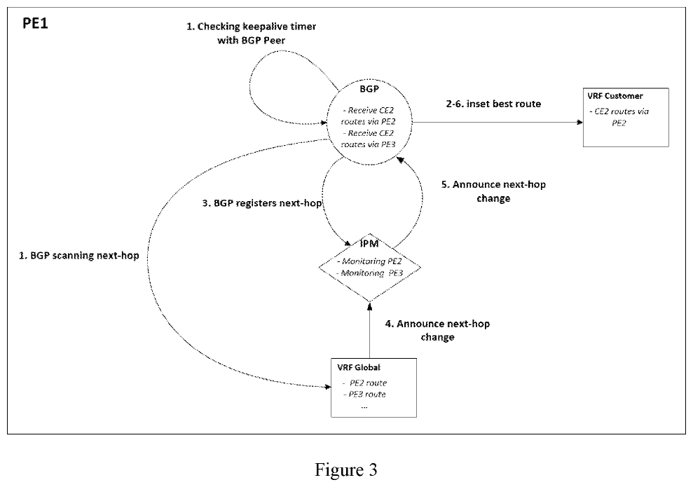

Step 2: On the PE device, the development team modified the border gate protocol (BGP) so that when it imports user routes into the VRF, if the BGP next-hop monitoring function is enabled, the BGP process will write the next-hops to be tracked into the IPM table. Specifically, this step does the following:
PE1 and PE2, PE3 advertises CE1 and CE2 user routes over the L3VPN channel established between PE1 and PE2, PE3 as shown in FIG. 1. After receiving user route information, the PE devices will import those routes into the corresponding virtual routing and forwarding (VRF) table for each CE. With the CE route and next-hop information in both the BGP routing table and the VRF table, CE1 and CE2 can now communicate with each other.
If in step 1 the next-hop monitoring feature has not been configured on PE1, then the next hop processing on PE1 is described as FIG. 2:
   Assuming user data sent from CE1 to CE2 arrives at PE1, PE1 calculates the next hop as PE2. If the PE2 device fails or hangs, it will take the BGP scanner process on PE1 60 seconds to detect an invalid PE2, or up to 180 seconds through the BGP session hold time check with PE2.
   Same for the process of user data sent from CE2 to CE1.
If the next-hop monitoring feature was turned on instead, the BGP protocol will register the next-hops to be tracked into the IP Monitoring (IPM) tables on the PE1 device as shown in FIG. 3. The next-hops to follow on PE1 are PE2 and PE3.

Step 3: The development team made a source code edit on the PE so that if there is a next hop related change event in the global VRF table, it will send a notification to the IPM table. The IPM table will then inform the routing table in the BGP protocol to recalculate the valid routes and the best routes. FIG. 3 depicts the process of setting up and handling the next-hop validation when there is a change as follows:
Assuming user data sent from CE1 to CE2 arrives at PE1, PE1 calculates the next hop as PE2. If the PE2 device fails or crashes, the information about PE2 in the global VRF on PE1 will be updated.
In device PE1, the global VRF will notify the IPM table about the change of PE2 information.
The IPM table in PE1 can receive a lot of information from the global VRF, but the IPM only records the information related to the next-hops that BGP registered to the IPM in step 2. Messages about subsequent hops not previously registered by BGP will be discarded by IPM.
IPM table will then notify the change of the next-hop PE2 for the BGP protocol. This notification happens immediately if the notification time is configured to be 0 seconds.
After BGP is notified by IPM of the PE2 next-hop change, BGP will recalculate which guest routes are valid and the best ones will be recorded to the user VRF. In this case, BGP on device PE1 will determine that the next best path is through next-hop PE3. This greatly shortens the user route verification time and data forwarding from CE1 to CE2 is restored in as fast as mini-seconds.

### Implementation Example

The method was implemented on the Site Router version EVT2 manufactured by VHT. The Site Router acts as a router at the provider's edge (PE) in the service provider's network. The Site Router establishes the BGP protocol and L3VPN with other PE devices in the network, creating a seamless channel for providing network services. Each user's routing information is recorded in their respective VRF table and next-hop monitoring is also enabled on all these VRFs.

Results

Comparison between using the three-label encapsulation multi-protocol label switching (MPLS) method and using the conventional MPLS method, shows that both methods are capable of providing layer 3 virtual private network service. However, there is a difference between these two methods in terms of economic efficiency, as shown in Table 1 below:

TABLE 1

| | Current method | Proposed method |
|---|---|---|
| Service convergence | 60-180 seconds | Miliseconds |
| time | | |
| Flexibility for service | No | Yes |
| deployment | | |
| Operational | Simple | Complex |
| Complexity | | |

Current method: although the operation is simple, the service interruption time when something goes wrong is very long, not meeting many user requirements.
Proposed method: the operation is more complicated due to the need for the next-hop monitoring function, but the convergence time is very short, meeting many service requirements of users.

In summary, the proposed invention provides a method for tracking the next-hop of a border gateway protocol in a Layer 3 virtual private network model. The method helps to determine the next-hop of a route as fast as possible. If the next-hop becomes invalid or the route to the next-hop has a change in cost, an update is carried out to ensure minimal convergence time.

1. A border gateway protocol next-hop monitoring method in a Layer 3 virtual private network model includes the following steps:
step 1: make a modification on a PE device that allows the creation of IP Monitoring (IPM) tables corresponding to a different virtual routing and forwarding (VRF) tables in the layer 3 virtual private network (L3VPN), wherein a L3VPN channel between different PEs must first be configured as follows:
configure the Open Shortest Path First (OSPF) protocol between devices PE1, P1, P2, PE2, and PE3;
configure a label broadcasting protocol: Label Distribution Protocol (LDP) or Resource Reservation Protocol (RSVP) between PE1, P1, P2, PE2, and PE3 devices;
configure a Border Gateway Protocol (BGP) between PE1 and PE2, PE3;
configure the user VRF information on PE1, PE2 and PE3;
on the PE1 device, in the BGP protocol, configure a next-hop monitoring feature to allow the creation of an IPM table, in this table, at first, there is no information about the next-hops to follow;
step 2: on the PE device, modify the border gate protocol (BGP) so that when it imports user routes into the VRF, if the BGP next-hop monitoring function is enabled, the BGP process will write the next-hops to be tracked into the IPM table, specifically, this step does the following:
PE1 and PE2, PE3 advertise CE1 and CE2 user routes over the L3VPN channel established between PE1 and PE2, PE3, after receiving user route information, the PE devices imports those routes into the corresponding virtual routing and forwarding (VRF) table for each CE, with the CE route and next-hop information in both the BGP routing table and the VRF table, CE1 and CE2 can now communicate with each other;
if in step 1 the next-hop monitoring feature has not been configured on PE1, then the next hop processing on PE1 is described as follows:
assuming user data sent from CE1 to CE2 arrives at PE1, PE1 calculates the next hop as PE2, if the PE2 device fails or hangs, it will take the BGP scanner process on PE1 60 seconds to detect an invalid PE2, or up to 180 seconds through the BGP session hold time check with PE2;
the above step is repeated for the process of user data sent from CE2 to CE1;
the next-hop monitoring feature was turned on instead, the BGP protocol will register the next-hops to be tracked into the IP Monitoring (IPM) tables on the PE1 device, the next-hops to follow on PE1 are PE2 and PE3;
step 3: if there is a next hop related change event in the global VRF table, send a notification to the IPM table the IPM table will then inform the routing table in the BGP protocol to recalculate the valid routes and the best routes, the process of setting up and handling the next-hop validation when there is a change is as follows:
assuming user data sent from CE1 to CE2 arrives at PE1, PE1 calculates the next hop as PE2, if the PE2 device fails or crashes, the information about PE2 in the global VRF on PE1 is updated;
in device PE1, the global VRF notifies the IPM table about the change of PE2 information;
while IPM table in PE1 can receive a lot of information from the global VRF, the IPM only records the information related to the next-hops that BGP registered to the IPM in step 2messages about subsequent hops not previously registered by BGP are discarded by IPM;
IPM table then notifies the change of the next-hop PE2 for the BGP protocol, the notification happens immediately if the notification time is configured to be 0 seconds;
after BGP is notified by IPM of the PE2 next-hop change, BGP recalculates which guest routes are valid and the best ones are recorded to the user VRF, in this case, BGP on device PE1 c determines that the next best path is through next-hop PE3, which greatly shortens the user route verification time and data forwarding from CE1 to CE2 is restored in as fast as mini-seconds.
